(19) United States
(12) Patent Application Publication
(10) Pub. No.: US 2013/0024076 A1
(43) Pub. Date: Jan. 24, 2013

(54) VEHICLE OPENING-AND-CLOSING MEMBER CONTROL DEVICE

(71) Applicants: Norio FUKUI, Kuwana-shi (JP); Shogo KIMURA, Toyota-shi (JP); Ryo ASANO, Owariasahi-shi (JP)

(72) Inventors: Norio FUKUI, Kuwana-shi (JP); Shogo KIMURA, Toyota-shi (JP); Ryo ASANO, Owariasahi-shi (JP)

(73) Assignee: AISIN SEIKI KABUSHIKI KAISHA, Kariya-shi (JP)

(21) Appl. No.: 13/551,834

(22) Filed: Jul. 18, 2012

(30) Foreign Application Priority Data
Jul. 19, 2011 (JP) 2011-158487

(51) Int. Cl. B60J 5/00

(52) U.S. Cl. 701/49

(57) ABSTRACT

A vehicle opening-and-closing member control device includes displacement amount detection portions provided at drive units and detecting respective displacement amounts of the drive units, a determination portion obtaining a difference of the displacement amounts and determining whether the drive unit is in failure on the basis of the difference, and a restriction portion restricting an operation state of the opening-and-closing member so as to be an operation disapproval state in a case where the determination portion determines that at least one of the drive units fails and at least one of the drive units operates normally. The restriction portion stops the operation of the drive units when a failure of drive unit is determined during the drive units are in operation, and the restriction portion prohibits the operation of the drive units thereafter when the failure of the drive unit is determined during the drive units are not in operation.

### CROSS REFERENCE TO RELATED APPLICATIONS

This application is based on and claims priority under 35 U.S.C. §119 to Japanese Patent Application 2011-158487, filed on Jul. 19, 2011, the entire content of which is incorporated herein by reference.

### TECHNICAL FIELD

This disclosure generally relates to a vehicle opening-and-closing member control device for controlling an opening/closing of an opening-and-closing member provided at a vehicle.

### BACKGROUND DISCUSSION

JP2007-10146A (hereinafter referred to as Patent reference 1) discloses a known vehicle opening-and-closing member control device, which is mounted to a vehicle, for automatically opening and closing an opening-and-closing member, for example, a liftgate at the back of a vehicle. The known vehicle opening-and-closing member control device of this type is configured to open and close the opening-and-closing member of the vehicle, for example, by a driving force of a damper drive unit (e.g., a motor), and is configured to open and close the opening-and-closing member by controlling a rotation speed of the damper drive unit so that an opening and closing speed of the opening-and-closing member is assumed to be a target speed. According to the known vehicle opening-and-closing member control device disclosed in Patent reference 1, a method for directly detecting a displacement of a spindle cylinder by a potentiometer or a method for detecting a displacement or a rotation speed of a drive transmission device by means of a Hall sensor is applied for detecting a door position and a door speed.

As disclosed in JP2007-331699A (hereinafter referred to as Patent reference 2), according to a construction in which multiple damper drive units are applied as a drive source for opening and closing a door, even if one of the drive units fails, in a case where the other of the drive units operates normally, the opening-and-closing member could be opened or closed only by the drive force of the other of the drive units depending on conditions, for example, an inclination level of the vehicle and variations of a motor output. In those circumstances, there is a drawback that the failure of the mentioned one of the drive units cannot be detected until the damper drive unit is activated under a condition in which the opening-and-closing member cannot be operated.

Particularly, in a case where the actuation is continued without detecting the failure of the mentioned one of the drive units, a load applied to the other of the drive units increases, which may induce a failure of the other one of the drive units. Further, in a case where one of the drive units fails, even if the opening-and-closing member can be properly operated on a level ground, the opening-and-closing member may abruptly open or close, for example, on an inclined road because of a lack of a drive force. Thus, there is a need for a countermeasure. A failure of the drive unit is detectable, for example, by detecting an electric current flowing at a motor. However, an electric current detection circuit is required to be provided for detecting the electric current, thus a need exists for detecting a failure with a simpler construction.

A need thus exists for a vehicle opening-and-closing member control device which is not susceptible to the drawback mentioned above.

### SUMMARY

In light of the foregoing, the disclosure provides a vehicle opening-and-closing member control device for performing an automatic opening and closing control of a vehicle opening-and-closing member by controlling a plurality of drive units having a drive force for operating the vehicle opening-and-closing member. The vehicle opening-and-closing member control device includes a plurality of displacement amount detection portions provided at said plurality of drive units, respectively, and detecting respective displacement amounts of the drive units, a determination portion obtaining a relative difference of the displacement amounts detected by the displacement amount detection portions and determining whether the drive unit is in failure on the basis of the difference of the displacement amounts, and a restriction portion restricting an operation state of the opening-and-closing member operated by the drive units so as to be an operation disapproval state where the opening-and-closing member cannot be operated by the drive units in a case where the determination portion determines that at least one of the drive units fails and at least one of the drive units operates normally. The restriction portion stops the operation of the drive units at the time when an occurrence of a failure of the drive unit or the drive units is determined during the drive units are in operation, and the restriction portion prohibits the operation of the drive units thereafter when the occurrence of the failure of the drive unit or the drive units is determined during the drive units are not in operation.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a rear portion of a vehicle for explaining an overview of a power liftgate apparatus according to a first embodiment disclosed here;

FIG. 2A is a cross-sectional view of a drive unit according to the embodiment disclosed here;

FIG. 2B is an exploded view of the drive unit according to the embodiment disclosed here;

FIG. 3 is an electrical schematic diagram of the power liftgate apparatus according to the first embodiment disclosed here;

FIG. 4 is a circuit diagram of an H bridge circuit according to the first embodiment disclosed here;

FIG. 5A shows a time chart for a control of a regenerative brake when a greater braking force is applied;

FIG. 5B shows a time chart for the control of the regenerative brake when a lower braking force is applied;

FIG. 6 is a flowchart executed for a failure determination;

FIG. 7 is a graph showing a temporal change of each displacement amount and a displacement amount difference under a condition where drive units at right hand side and left hand side are not in failure;

FIG. 8 is a graph showing a temporal change of each displacement amount and a displacement amount difference under a condition where a motor for the drive unit at right hand side is in failure so as not to output a drive force; and

FIG. 9 is a graph showing a temporal change of each displacement amount and a displacement amount difference under a condition where the motor for the drive unit at right hand side falls off from a rear door.

### DETAILED DESCRIPTION

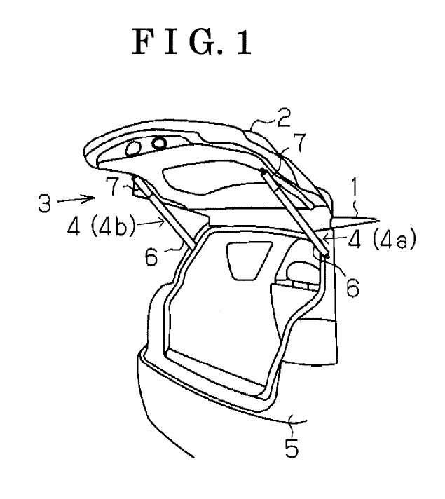

One embodiment of a vehicle opening-and-closing member control device will be explained with reference to FIGS. 1 to 9 as follows.

As shown in FIG. 1, a vehicle 1 is provided with a power liftgate apparatus (i.e., serving as a vehicle opening-and closing member control device) 3 for automatically opening and closing a rear door (i.e., serving as an opening and closing member) 2 of the vehicle 1. A damper drive type apparatus is applied as the power liftgate apparatus 3, in which the rear door 2 is automatically openable and closable relative to a vehicle body 5 by a pair of damper type drive units 4, 4, which is arranged in a width direction of the vehicle body. According to the embodiment, the drive unit 4 provided at right hand side in FIG. 1 is defined as a right hand side drive unit 4a, and the drive unit 4 provided at left hand side in FIG. 1 is defined as a left hand side drive unit 4b. The rear door 2 serves as an opening-and-closing member. The power liftgate apparatus 3 serves as a vehicle opening-and-closing member control device.

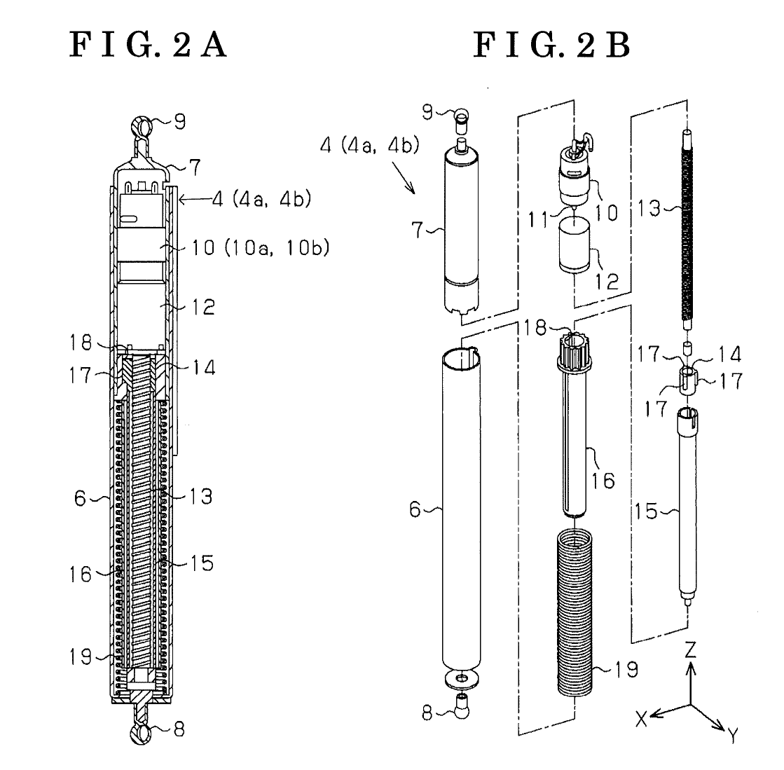

As shown in FIGS. 2A and 2B, the drive unit 4 includes a cover cylinder 6. A housing cylinder 7 is housed inside the cover cylinder 6 so as to linearly reciprocate in an axial direction (i.e., a Z-axis direction in FIG. 2B). A joint 8 is provided at an open end of the cover cylinder 6. Similarly, a joint 9 is provided at an open end of the housing cylinder 7. According to the drive unit 4, the joint 8 is connected to the vehicle body 5, and the joint 9 is connected to the rear door 2.

A motor (i.e., serving as a drive portion) 10 for drive unit, which serves as a drive source for the drive unit 4, is housed inside the housing cylinder 7. According to the embodiment, the motor 10 for drive unit includes a motor 10a for right hand side drive unit provided at the right hand side drive unit 4a and a motor 10b for left hand side drive unit provided at the left hand side drive unit 4b. A rod shaped screw spindle 13 is coaxially fixed to a motor shaft 11 of the motor 10 for drive unit, for example, via a transmission device 12 having a deceleration function. The screw spindle 13 includes an outer peripheral screw portion onto which a spindle nut 14 is attached, and is extended within a spindle cylinder 15 so as to be relatively rotatable. One end of the spindle cylinder 15 is fixed to the spindle nut 14, and the other end of the spindle cylinder 15 is fixed to the joint 8. The motor 10 (10a, 10b) for drive unit serves as a drive portion.

A guide cylinder 16 is housed inside the cover cylinder 6. The screw spindle 13, the spindle nut 14, and the spindle cylinder 15 are housed inside the guide cylinder 16. Supporting projections 17 which protrude in radial directions are provided on an outer periphery of the spindle nut 14 in a circumferential direction. The supporting projections 17 are engageably inserted into slits 18 formed on the guide cylinder 16 to extend in an axial direction, respectively. A compression coil spring 19 for retaining the rear door 2 at a position is mounted to an outer periphery of the guide cylinder 16. The compression coil spring 19 has a biasing force including a reaction force which balances with a weight of the rear door 2 when opening or which is greater than the weight of the rear door 2.

When the motor 10 for drive unit rotates, the screw spindle 13 rotates. In those circumstances, a revolving motion of the motor 10 for drive unit is converted into a linear motion of the spindle nut 14 by means of the screw spindle 13 and the spindle nut 14. The spindle nut 14 and the spindle cylinder 15 move linearly because the spindle nut 14 is guided by the supporting projections 17 and the slits 18. Accordingly, the cover cylinder 6 moves relative to the housing cylinder 7 to open the rear door 2.

According to the embodiment, by a normal rotation (rotation in a normal direction) of the motors 10a, 10b for drive units during an automatic opening operation in which the rear door 2 is automatically operated, the cover cylinder 6 is linearly moved in a direction to elongate a length of the drive unit 4 defined by the cover cylinder 6 and the housing cylinder 7 (in a direction to be away from the housing cylinder 7) to open the rear door 2. On the other hand, when automatically closing the rear door 2, the motors 10a, 10b for drive units are rotated in reverse to linearly move the cover cylinder 6 in a direction to shorten the length of the drive unit 4 defined by the cover cylinder 6 and the housing cylinder 7 (in a direction to be closer to the housing cylinder 7), thus closing the rear door 2.

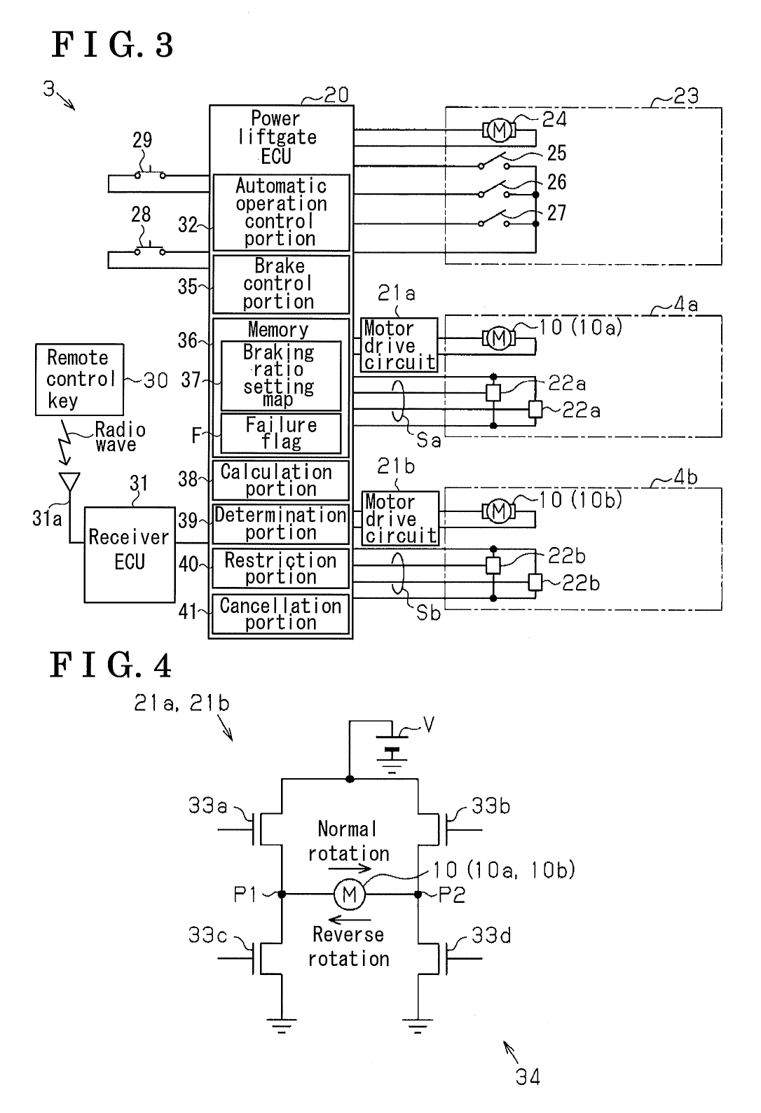

As shown in FIG. 3, the power liftgate apparatus 3 is provided with a power liftgate ECU (electronic control unit) 20 for controlling the operation of the power liftgate apparatus 3. The power liftgate ECU 20 is connected to the motor 10a for right hand side drive unit via a motor drive circuit (i.e., serving as a drive circuit) 21a, and is connected to the motor 10b for left hand side drive unit via a motor drive circuit 21b. The power liftgate ECU 20 simultaneously actuates the motors 10a, 10b for drive units to execute the automatic opening operation and the automatic closing operation of the rear door 2.

Plural (e.g., two) pulse sensors 22a, 22a for detecting the rotation speed of the motor 10a for right hand side drive unit is provided at the right hand side drive unit 4a. The pulse sensors 22a, 22a are connected to the power liftgate ECU 20. For example, a magnetic sensor is applied as the pulse sensors 22a, 22a. The pulse sensors 22a, 22a detect a magnetic field of a magnet rotor mounted to the motor shaft 11 of the motor 10a for right hand drive unit by a Hall sensor provided at a housing side, and outputs a pulse signal (detection signal) Sa to the power liftgate ECU 20 in accordance with the rotation speed of the motor 10a for right hand side drive unit. The plural (e.g., two) pulse sensors 22a, 22a are provided for detecting a rotational direction of the motor 10a for right hand side drive unit. The pulse sensor 22a serves as a displacement amount detection portion and an operation state detection portion.

Plural (e.g., two) pulse sensors 22b, 22b for detecting the rotation speed of the motor 10b for left hand side drive unit is provided at the left hand side drive unit 4b. For example, a magnetic sensor is applied as the pulse sensors 22b, 22b, and outputs a pulse signal (detection signal) Sb to the power liftgate ECU 20 in accordance with the rotation speed of the motor 10b for left hand side drive unit. The pulse sensor 22b serves as a displacement amount detection portion and an operation state detection portion.

The power liftgate apparatus 3 is provided with a door closer apparatus 23 for automatically close the rear door 2, which is in a half-latched state, to be a completely closed state. A motor 24 for door closer which is a drive source for the door closer apparatus 23 is connected to the power liftgate ECU 20. The door closer apparatus 23 operates an operation lever from a neutral position in a closing direction by the motor 24 for door closer when the rear door 2 is at an immediately before completely closed position to retract a latch to engaged with a striker, thus completely closing the rear door 2. Thereafter, the operation lever operated in the closing direction returns to the neutral position by the motor 24 for door closer.

The door closer apparatus 23 is configured to operate the operation lever from the neutral portion in a releasing direction by the motor 24 for door closer in a state where the rear door 2 is completely closed to disengage the latch from the striker, thus opening the rear door 2. Then, the operation lever operated in the releasing direction returns to the neutral position by the motor 24 for door closer.

The door closer apparatus 23 includes a position switch 25 for detecting whether the latch (operation lever) is in the neutral position, a half latch switch 26 for detecting that the rear door 2 is in the half-latched state when detecting that the latch is in a retaining state, or the half-latched state, and a full latch switch 27 for detecting that the rear door 2 is completely closed when detecting that the latch is completely fitted to the striker. The power liftgate ECU 20 is configured to confirm (determine) the operational state of the door closer apparatus 23 by the inputs of the detection signals from the switches 25 to 27.

The power liftgate ECU 20 confirms (determines) that the rear door 2 is fully closed (i.e., fully closed state) when an ON signal is inputted from the full latch switch 27 of the door closer apparatus 23, and thus calculates a door position (opening-and-closing position) of the rear door 2 by measuring a pulse of a pulse signal Sa (Sb) inputted from the pulse sensor 22a (22b) with reference to the fully closed state. Further, the power liftgate ECU 20 calculates a door speed (opening-and-closing speed) of the rear door 2 on the basis of a pulse input timing of the pulse signal Sa (Sb) inputted from the pulse sensor 22a (22b). Still further, the power liftgate ECU 20 calculates an operational direction of the rear door 2 by confirming an inputting order of each of the pulse signals Sa, Sa (Sb, Sb) inputted from the pulse sensors 22a, 22a (22b, 22b).

The power liftgate ECU 20 is connected to an open switch 28 which is operated when automatically opening the rear door 2 which is in the fully closed state. The power liftgate ECU 20 is connected to a close switch 29 which is operated when automatically closing the rear door 2 which is in an open state. The power liftgate ECU 20 executes an automatic opening operation when detecting that the open switch 28 is operated. On the other hand, the power liftgate ECU 20 executes an automatic closing operation when detecting that the close switch 29 is operated.

The power liftgate apparatus 3 includes a remote control function for executing the automatic opening operation or the automatic closing operation of the rear door 2 by a remote control by means of a remote control key 30. In those circumstances, a receiver ECU 31 configured to have a wireless communication with the remote control key 30 is connected to the power liftgate ECU 20. Upon receiving a transmitting radio wave from the remote control key 30 by an antenna 31a, the receiver ECU 31 determines whether a key which transmits the radio wave is valid, and outputs a request for executing the automatic opening operation or the automatic closing operation to the power liftgate ECU 20 when the validity of the key is confirmed. The power liftgate ECU 20 executes the automatic opening operation or the automatic closing operation when the request for executing the automatic opening operation or the automatic closing operation is inputted from the receiver ECU 31.

The power liftgate ECU 20 includes an automatic operation control portion (i.e., serving as an operation control portion) 32 for controlling the automatic opening operation or the automatic closing operation of the rear door 2. The automatic operation control portion 32, according to the embodiment, executes an opening and closing of the rear door 2 by a speed control for operating the rear door 2 to be a target speed. A type of a feedback control, for example, a pulse width modulation control (PWM control) is applied for the speed control for the embodiment. The PWM control controls the door speed to follow a target speed by changing a duty ratio of an electric voltage applied to the motor, the motor 10a for right hand side drive unit and the motor 10b for left hand side drive unit. The automatic operation control portion 32 is configured to execute a feedback control of rotation speeds of the motor 10a for right hand side drive unit and the motor 10b for left hand side drive unit so that the rotation speeds of the motor 10a and the motor 10b assume to be equal, thus automatically opening and closing the rear door 2. The automatic operation control portion 32 serves as an operation control portion.

As shown in FIG. 4, each of the motor drive circuits 21a, 21b includes an H bridge circuit 34 in which switching elements (e.g., four switching elements) 33a, 33b, 33c, 33d are arranged in an H-shape. The first switching element 33a and the second switching element 33b are connected to a battery V, and the third switching element 33c and the fourth switching element 33d are grounded. The motor 10a for right hand side drive unit (motor 10b for left hand side drive unit) is arranged between an intermediate point P1 of the switching element 33a and the third switching element 33c and an intermediate point P2 of the second switching element 33b and the fourth switching element 33d. The H bridge circuit 34 serves as a brake portion (regenerative brake portion).

When performing the automatic opening operation, the automatic operation control portion 32 supplies an electric current to the motor 10a for right hand side drive unit and the motor 10b for left hand side drive unit for rotating the motors 10a, 10b in a normal direction by connecting (i.e., ON; turning on) the first switching element 33a and the fourth switching element 33d and by disconnecting (i.e., OFF; turning off) the second switching element 33b and the third switching element 33c. Then, the automatic operation control portion 32 controls the opening speed of the rear door 2 by controlling a switching timing (i.e., On/Off switching timing) of the first switching element 33a and the fourth switching element 33d so that the rotation speed of the motor 10a for right hand side drive unit and the motor 10b for left hand side drive unit follows the target value.

On the other hand, when performing the automatic closing operation, the automatic operation control portion 32 supplies an electric current to the motor 10a for right hand side drive unit and the motor 10b for left hand side drive unit for rotating the motors 10a, 10b in a reverse direction by turning on (i.e., ON; connecting) the second switching element 33b and the third switching element 33c and by turning off (i.e., OFF; disconnecting) the first switching element 33a and the fourth switching element 33d. Then, the automatic operation control portion 32 controls the closing speed of the rear door 2 by controlling a switching timing (i.e., On/Off switching timing) of the second switching element 33b and the third switching element 33c so that the rotation speed of the motor 10a for right hand side drive unit and the motor 10b for left hand side drive unit follows the target value.

During the automatic opening operation and the automatic closing operation, for example, in a case where a force is manually applied to the rear door 2 in the same direction to the electrically operating direction of the rear door 2 or where the vehicle 1 is stopped on a sharp slope, the rear door 2 may open or close with abrupt speed. In those circumstances, the door speed of the rear door 2 may largely exceed the target speed and the door speed may not be able to accord to the target speed only by the PWM control. Under the foregoing conditions, it is effective to compulsorily reduce the door speed of the rear door 2 by applying a braking force to the rear door 2.

According to the construction of the embodiment, the power liftgate ECU 20 includes a brake control portion (i.e., serving as a brake portion) 35 for compulsorily reduce the door speed by applying a brake force to the rear door 2 in a state where the door speed of the rear door 2 is considered to be largely fluctuated, for example, by a manual operation. The brake control portion 35 of the embodiment executes the brake control for applying the brake force to the rear door 2 by generating a regenerative brake by establishing a closed circuit at the motor drive circuits 21a, 21b (H bridge circuit 34). The brake control portion 35 serves as a brake portion (regenerative brake portion).

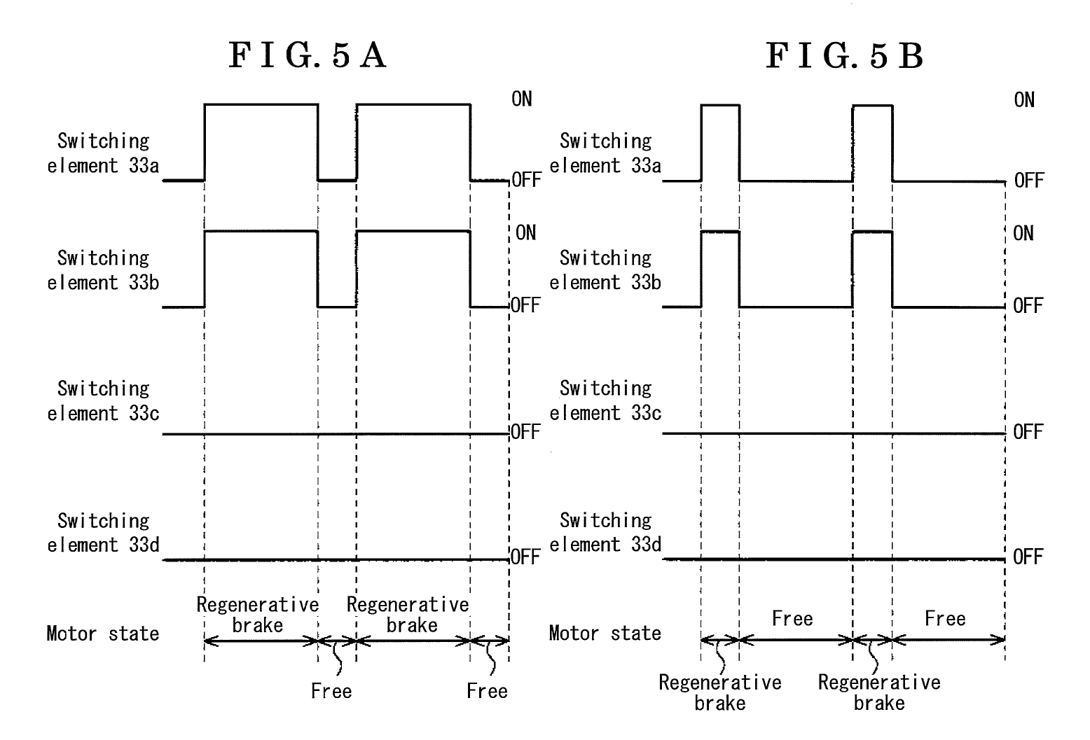

As shown in FIG. 5, the H bridge circuit 34 is assumed to be a state corresponding to a regenerative brake when the first switching element 33a and the second switching element 33b are in an ON state and the third switching element 33c and the fourth switching element 33d are in an OFF state. When all of the switching elements 33a, 33b, 33c, 33d are in the OFF state, the H bridge circuit 34 is assumed to be a free state in which the regenerative brake is released (canceled). The brake control portion 35 applies a brake force to the rear door 2 by alternately setting the regenerative brake state and the free state by switching the ON state and the OFF state of the switching elements 33a, 33b, 33c, 33d with high speed.

The brake control portion 35 computes a braking ratio based upon a door opening degree at the timing or a door speed at the timing, referring to a braking ratio setting map 37 which is stored in a memory 36, and generates the regenerative brake on the basis of the computed braking ratio. The braking ratio is determined (set) by switching a temporal ratio of the regenerative brake state and the free state, that is, by switching a length of an ON time per each cycle of the first switching element 33a and the second switching element 33b. For example, as shown in FIGS. 5A, a brake force is set to be higher when the ON time is set longer, and the brake force is set to be lower when the ON time is shorter as shown in FIG. 5B.

As described in the background of the disclosure, one of the right hand side drive unit 4a and the left hand side drive unit 4b may fail in some occasion. In those circumstances, provided that the actuation of the power liftgate apparatus 3 is allowed, the opening and closing operation of the rear door 2 is executed by the other of the right hand side drive unit 4a and the left hand side drive unit 4b which is not failed, which may induce a failure of the mentioned the other of the right hand side drive unit 4a and the left hand side drive unit 4b and/or may cause an abrupt opening or closing operation of the rear door 2. Thus, in a case where one of the right hand side drive unit 4a and the left hand side drive unit 4b fails, it is necessary to detect the failure.

According to the construction of the embodiment, the power liftgate apparatus 3 includes a failure determination function for determining whether the drive unit 4a, 4b fails on the basis of a displacement amount difference M of the right hand side and left hand side motors 10a, 10b. The power liftgate ECU 20 includes a displacement amount calculation portion 38 (also refereed to as a calculation portion) for calculating displacement amounts Kr, KI of the right hand side and left hand side drive units 4a, 4b, respectively. The displacement amount calculation portion 38 calculates the displacement amounts Kr, KI of the motors 10a, 10b, respectively, that is, an extension position (telescopic position)(i.e., serving as a drive position) of the drive units 4a, 4b obtained from the rotation speeds of the motors 10a, 10b by measuring pulse edges which generates by four per one rotation of the motors 10a, 10b. The displacement amount calculation portion 38 measures the pulse edges with respect to the position zero (0) where the fully closed state of the door is detected. The displacement amount calculation portion 38 serves as a displacement amount calculation portion.

The power liftgate ECU 20 includes a failure determination portion (i.e., serving as a determination portion) (also refereed to as a determination portion) 39 for determining whether the drive unit 4a, 4b fails using each of the displacement amounts Kr, KI calculated by the displacement amount calculation portion 38. The failure determination portion 39 calculates a difference of the displacement amounts Kr, KI (i.e., hereinafter referred to as a displacement amount difference M), and determines whether the displacement amount difference M is within a threshold range α. The displacement amount difference M corresponds to the absolute value of the difference of the displacement amount Kr and the displacement amount KI (i.e., |Kr-KI|). The threshold range α is set to be a range of values by which that the drive unit 4a, 4b does not fail is determined in a case where the displacement amount difference M falls therewithin while considering output variations of the right hand side and left hand side motors 10a, 10b and load variations of the compression coil spring 19 of the drive unit 4. The failure determination portion 39 determines that no failure occurs when confirming that the displacement amount difference M falls within the threshold range α, and determines that failure occurs when confirming that the displacement amount M exceeds the threshold range α. The failure determination portion 39 serves as a determination portion.

The power liftgate ECU 20 includes an operation restriction portion (i.e., serving as a restriction portion) (also referred to as a restriction portion) 40 for compulsorily stopping the automatic operation (electric opening and closing) of the power liftgate apparatus 3 when the failure determination portion 39 determines that one of the right hand side drive unit 4a and the left hand side drive unit 4b fails (i.e., failure occurs). The operation restriction portion 40 is configured to set an operation mode of the power liftgate apparatus 3 to be in an automatic operation disapproval state (operation disapproval state), for example, by setting a failure flag F at the memory 36 in the power liftgate ECU 20, when it is determined that failure occurs. In a case where more than three drive units are provided, the failure determination portion 39 determines an occurrence of failure when at least one of the drive units fails and at least one of drive units operates normally. The operation restriction portion 40 serves as a restriction portion.

During the automatic operation disapproval state, the operation restriction portion 40 compulsorily ends an energization (electric supply) to the motors 10a, 10b for drive units to disapprove the automatic opening operation and the automatic closing operation, and controls a braking of the rear door 2 to reduce the speed of the rear door 2 by the regenerative brake. The brake is applied to the rear door 2 during the automatic operation disapproval state for the purpose of retaining the rear door 2 with a force higher than in a normal state. In those circumstances, the brake control portion 35 generates the regenerative brake with a predetermined braking ratio (e.g., 100% braking ratio). During the automatic operation disapproval state of the power liftgate apparatus 3, the electric opening and closing operation is not executed even if the open switch 28, the close switch 29, and the remote control key 30 are operated, and only manual opening and closing operation is allowed.

The power liftgate ECU 20 includes a restriction cancellation portion (i.e., serving as a cancellation portion) (also refereed to as a cancellation portion) 41 for canceling the automatic operation disapproval state of the power liftgate apparatus 3. The restriction cancellation portion 41 is configured to return (restore) the operation mode of the power liftgate apparatus 3 to the normal state by clearing the failure flag F set at the memory 36 when inputting a failure information deletion command, for example, from a tool connected to the vehicle body 5. Thus, the electric opening and closing operation of the power liftgate apparatus 3 can be executed again. The restriction cancellation portion 41 serves as a cancellation portion.

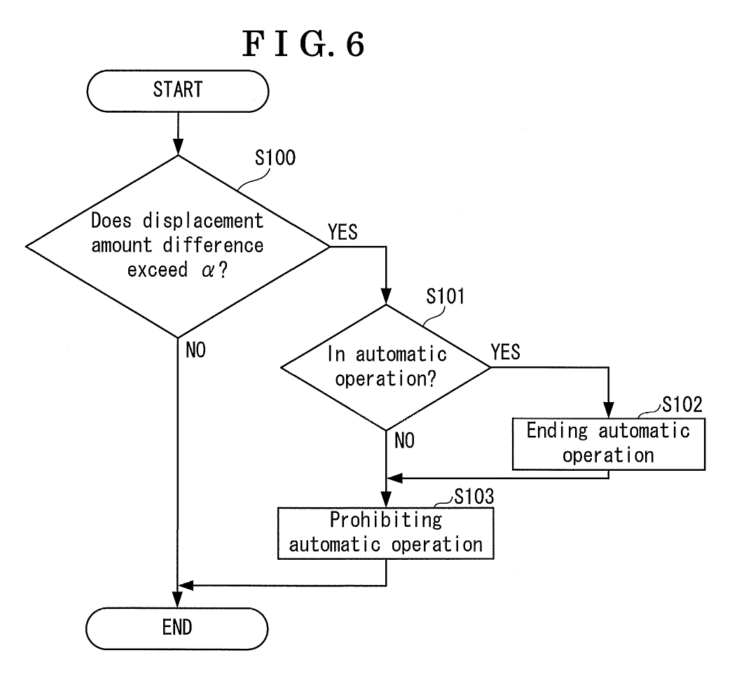

Next, an operation of the power liftgate apparatus 3 will be explained with reference to FIGS. 6 to 9. A flow chart shown in FIG. 6 is repeatedly executed during the opening and closing operation of the power liftgate apparatus 3. The operation presupposes that the door position of the rear door 2, that is the displacement amounts Kr, KI of the right hand side and the left hand side drive units 4a, 4b, is monitored irrespective of a type of operation, that is, irrespective of whether the opening and closing operation is performed electrically or manually.

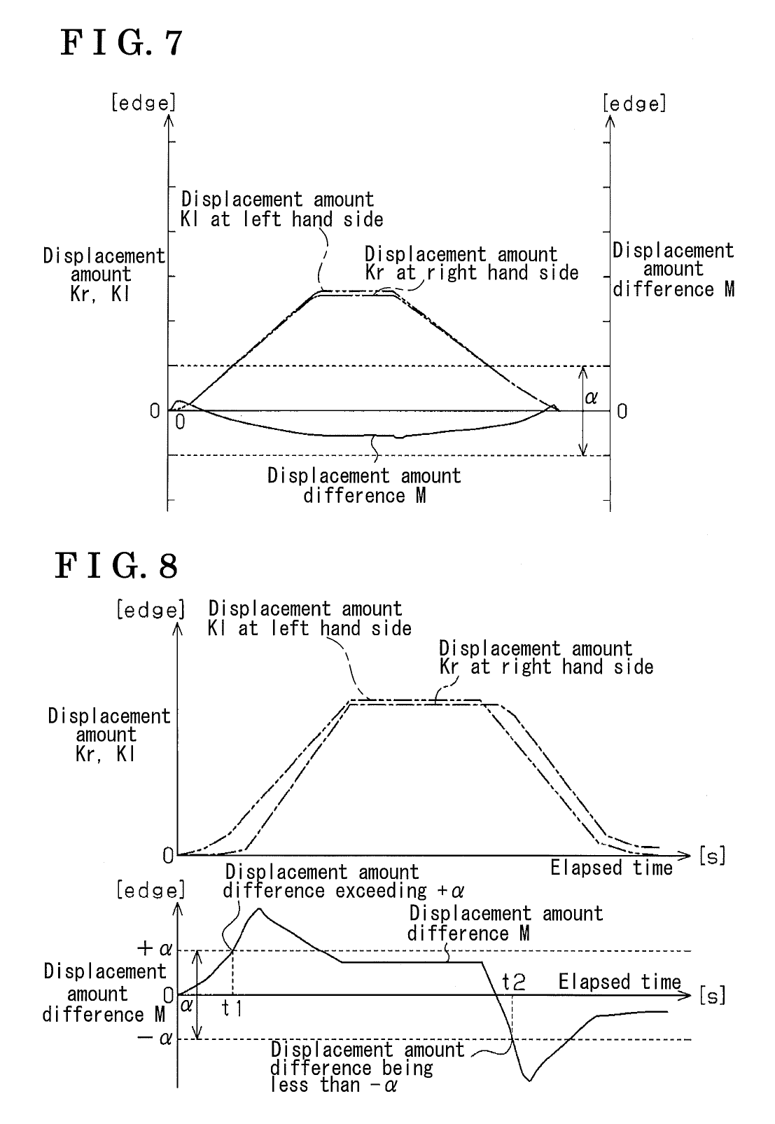

FIG. 7 shows a graph showing temporal changes of the displacement amounts Kr, KI and the displacement amount difference M under a condition where none of the right hand side and left hand side drive units 4a 4b fails. In FIG. 7, a horizontal axis shows an elapsed time (s), a vertical axis at left hand side shows a displacement amount [edge], and a vertical axis at right hand side shows a displacement amount difference [edge]. As shown in FIG. 7, in a case where none of the right hand side and left hand side drive units 4a, 4b fails, the displacement amount difference M falls within the threshold range α although a certain level of the displacement amount difference M is generated due to torque variations of the right hand side and left hand side motors 10a, 10b and load variations of the compression coil spring 19 of the drive units 4a, 4b. Thus, the failure determination portion 39 recognizes that both of the drive units 4a, 4b operate properly (in a normal state), and allows the automatic operation (i.e., automatic opening operation, automatic closing operation) by the automatic operation control portion 32.

FIG. 8 shows a graph which illustrates temporal changes of the displacement amounts Kr, KI and a temporal change of the displacement amount difference M under a condition where the motor 10a of the right hand side drive unit 4a fails, thus not generating the drive force, and only the left hand side drive unit 4b operates properly (in a normal state). In those circumstances, because the drive force only from the motor 10b for left hand side drive unit works, the displacement amount KI at left hand side increases first, and the displacement amount Kr at the right hand side increases preceded by the displacement amount KI because the right hand side drive unit 4a is restrained by the rear door 2 and the vehicle body 5. Accordingly, the displacement amount difference M gradually increases to exceed (to be out of) the threshold range α at time t1 and time t2 as shown in FIG. 8 (i.e., the displacement amount difference M exceeds +a at time t1 and the displacement amount difference M is assumed to be lower than −α at time t2).

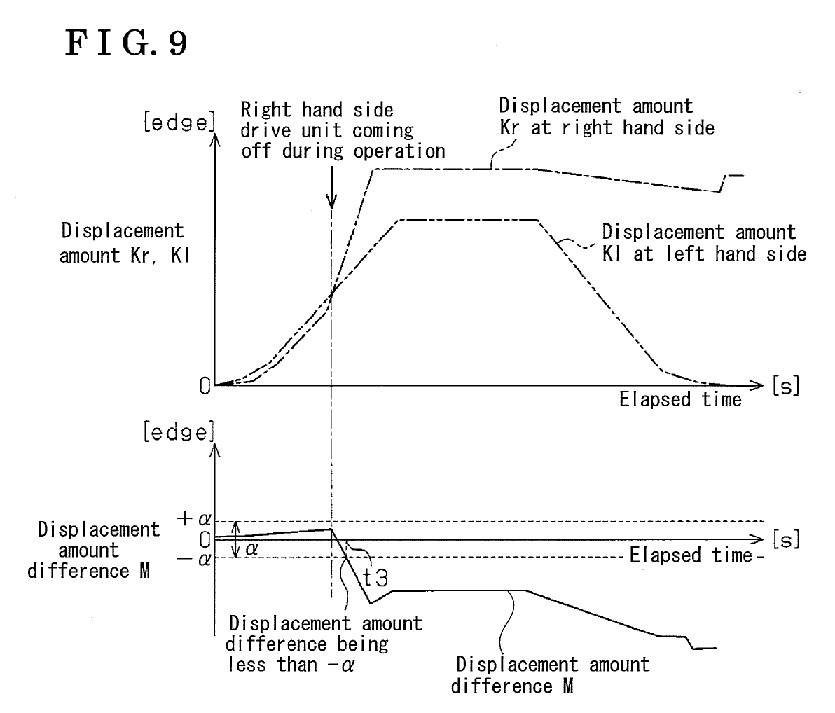

FIG. 9 shows a graph illustrating temporal changes of the displacement amount Kr, KI and a graph illustrating a temporal change of the displacement amount difference M under a condition, for example, that the motor 10a for right hand side drive unit comes off from the rear door 2. In those circumstances, because the right hand side drive unit 4a comes off from the rear door 2, the force for compressing the right hand side drive unit 4a is not applied by a self weight of the rear door 2 and, instead, a force in an expanding direction by the compression coil spring 19 is applied to constantly operate the right hand drive unit 4a in the expanding direction. Accordingly, the displacement amount difference M sharply increases during the operation, and as shown in FIG. 9, the displacement amount difference M exceeds (is assumed to be out of) the threshold range α at time t3 (i.e., the displacement amount difference M is assumed to be lower than −α at time t3).

In Step S100, as shown in FIG. 6, the failure determination portion 39 determines whether the displacement amount difference M exceeds the threshold range α (α is the absolute value). In those circumstances, as shown in FIG. 7, in a case where the displacement amount difference M falls within the threshold range α, it is determined that no failure occurs and end the transaction of the flowchart. As shown in FIGS. 8 and 9, in a case where the displacement amount difference M exceeds (is assumed to be out of) the threshold range α, it is determined that failure occurs, and the transaction advances to Step S101.

In Step S101, the operation restriction portion 40 determines whether the rear door 2 is in an automatic operation (in an automatic opening operation, in an automatic closing operation). In a case where the rear door 2 is in the automatic operation, the transaction advances to Step S102. In a case where the rear door 2 is not in the automatic operation, the transaction advances to Step S103.

In Step S102, the operation restriction portion 40 compulsorily ends the automatic operation which is in execution. Namely, when failure occurs, the operation restriction portion 40 sets the failure flag F at the memory 36 in the power liftgate ECU 20 to set the operation mode of the power liftgate apparatus 3 to be in the automatic operation disapproval state. Thus, the electric opening and closing of the rear door 2 is compulsorily ended, and is assumed to be opened or closed manually. In those circumstances, the brake control portion 35 generates the regenerative brake by the H bridge circuit 34 to restrain the door speed of the rear door 2 to be lower. Further, during the failure flag F is set at the memory 36, the rear door 2 cannot be opened or closed by the electrical operation, and can be opened or closed only manually.

In Step S103, the operation restriction portion 40 prohibits the automatic operation thereafter. Namely, in a case where a failure occurs (where, for example, the drive unit 4a fails), the operation restriction portion 40 sets the failure flag F at the memory 36 so that the power liftgate apparatus 3 is assumed to be in the automatic operation disapproval state, and the automatic operation thereafter is prohibited. Accordingly, the electric opening and closing operation thereafter is prohibited, and the rear door 2 is only manually operable.

The failure flag F at the memory 36 is cleared (deleted) by a tool, for example, provided at a dealer. For example, the tool is inserted into a connector of the vehicle body 5, and a failure information deletion command (request) is inputted to the power liftgate ECU 20 from the tool. In those circumstances, confirming the input of the failure information deletion command (request), the restriction cancellation portion 41 clears the failure flag F at the memory 36 to cancel the automatic operation disapproval state (operation prohibition state) of the power liftgate apparatus 3. Accordingly, after repairing the drive unit 4, the opening and closing of the rear door 2 can be electrically performed as before.

According to the construction of the embodiment, as described above, the displacement amount difference M of the displacement amount Kr of the right hand side drive unit 4a and the displacement amount KI at the left hand side drive unit 4b is obtained, and it is determined that one of the drive units 4a, 4b fails when the displacement amount difference M exceeds (is out of) the threshold range α so as to stop or prohibit the automatic operation. Thus, whether the drive unit 4a, 4b fails can be determined with a simple construction using the displacement amount difference M. Further, because there is no need to use expensive parts, for example, an electric current detection circuit, the manufacturing cost is not increased even if the failure determination function is provided.

Further, according to the failure determination disclosed in the embodiment, a failure of one of the drive units 4a, 4b can be determined. This prevents the power liftgate apparatus 3 from being continuously used in a state where one of the drive units 4a, 4b is in failure, thus lowering a possibility for inducing a failure of the other of the drive units 4a, 4b. Accordingly, an expansion of a failure influence because of the continuous use of the drive units 4a, 4b without noticing the failure of one of the drive units 4a, 4b can be prevented.

According to the construction of the embodiment, the following effects and advantages can be attained.

First, because whether a failure occurs is determined on the basis of the displacement amount difference M of the displacement amount Kr of the right hand side drive unit 4a and the displacement amount KI of the left hand side drive unit 4b, an occurrence of the failure of a particular unit among one of the plural drive units 4a, 4b can be determined with a simple construction for confirming the displacement amount difference M. Accordingly, an occurrence of the failure of a particular drive unit, that is, one of the plural drive units 4a, 4b can be detected with a simple construction.

Second, when an occurrence of the failure is determined during the automatic operation of the rear door 2, the automatic operation in execution is compulsorily stopped, and when an occurrence of the failure is determined during the automatic operation of the rear door 2 is not in operation, the automatic operation thereafter is prohibited. Thus, irrespective of the states of the drive unit 4 (power rear door apparatus 3), that is, irrespective of whether the drive unit 4 (power liftgate apparatus 3) is in operation or not in operation, the drive unit 4 can be transited to the automatic operation disapproval state.

Third, when the drive unit 4 is in the automatic operation disapproval state, the failure flag F is set at the memory 36 of the power liftgate ECU 20, and the automatic operation disapproval state is maintained until the failure flag F is deleted, or cleared by a repair of the drive unit 4. Thus, the automatic operation disapproval state cannot be canceled unless the failure is repaired. This contributes to ensure a safety of a user when operating the rear door 2.

Fourth, when an occurrence of the failure is determined during the automatic operation, because a brake is applied to the rear door 2, the rear door 2 having the drive unit 4 that is in a failure mode can be operated safely. This further contributes to ensure a safety of a user when operating the rear door 2.

Fifth, the displacement amounts Kr, KI correspond to the extension position of the drive units 4a, 4b obtained from the rotation speed of the motors 10a, 10b for drive units, and the displacement amount difference M corresponds to a difference between the extension positions of the drive units 4a, 4b. Thus, an occurrence of the failure of the drive units 4a, 4b can be detected with a simple construction which determines an occurrence of the failure based on the difference between the extension positions of the drive units 4a, 4b.

Sixth, the automatic opening operation and the automatic closing operation is controlled by a feedback control using, for example, a PWM control. Thus, because the rear door 2 can be opened and closed following the predetermined target speed, the rear door 2 can be opened and closed with a favorable door speed. This contributes to ensure safety for opening and closing operation of the rear door 2.

Seventh, because a regenerative brake is applied as a brake for the rear door 2, a brake force can be applied to the rear door 2 with a simple construction for switching circuit states of the motor drive circuits 21a, 21b to be a closed state (closed circuit).

The vehicle opening-and-closing member control device is not limited to the embodiment explained above, and may be modified as follows. The automatic operation disapproval state may continue for a predetermined time. A condition for canceling the operation disapproval state may include that a predetermined time is elapsed from a time when the opening-and-closing member is assumed to be the operation disapproval state. A method for canceling the automatic operation disapproval state is not limited to the method in which the failure flag F of the memory 36 is cleared by the tool provided at, for example, a dealer. For example, alternatively, operating various switches and/or components provided at the vehicle body 5 by predetermined times and by a predetermined order may be set as a condition for canceling the automatic operation disapproval state. Further, alternatively, the failure flag F of the memory 36 may be automatically deleted, or cleared when replacing the failed drive unit 4 with a new drive unit (a new part).

A type of the drive unit 4 is not limited to a damper type clutch-less drive unit, and as long as allowing an automatic opening and closing operation of the rear door 2 by a drive source, any unit is applicable as the drive unit 4. A method for the detection of a closed state of the rear door 2 is not limited to using a switch of the door closer apparatus 23. For example, alternatively, a switch or a sensor exclusive for detecting the closed state of the door may be provided.

A braking ratio applied to the rear door 2 when the drive unit 4a, 4b is in failure is not limited to 100%, and may be changeable to other values, or ratio. Further, a brake force applied to the rear door 2 when the drive unit 4a, 4b is in failure may be variable depending on, for example, a door speed and/or a door position.

When it is determined that the drive unit 4 is in failure, it is not necessary to apply a brake force to the rear door 2, and this transaction may be omitted. A configuration of the regenerative brake is not limited to switching a braking ratio by changing an ON time of a pulse per one cycle. For example, alternatively, a braking ratio may be switched by changing frequency (number of times) of an ON time in a predetermined time.

A brake portion is not limited to a regenerative brake. Alternatively, for example, a brake including a clutch may be applicable. A displacement amount detection portion is not limited to the pulse sensors 22a, 22b. Alternatively, other sensors and switches may be applied as the displacement amount detection portion.

A feedback control of the rear door 2 is not limited to a PWM control. As long as a door speed is controlled to follow a target speed, other control methods are applicable. An automatic opening operation and an automatic closing operation of the rear door 2 is not limited to be executed by a feedback control. Alternatively, for example, the automatic opening operation and the automatic closing operation of the rear door 2 may be executed by a constant speed control.

When controlling the motors 10a, 10b for right hand side and left hand side drive units to have the same operation, the control is not limited to a control for making rotation speeds at right hand side and left hand side motors 10a, 10b be the same. For example, extension positions of the drive units 4a, 4b at right hand side and left hand side may be controlled to be the same.

The drive source for the drive unit 4 is not limited to the motor. Alternatively, for example, a hydraulic cylinder may be applied as the drive source for the drive unit 4. The opening-and-closing member is not limited to the rear door 2. For example, a slide door, a luggage door, and a sunroof may be applied as the opening-and-closing member.

The displacement amount detection portion and the operation state detection portion are not limited to be served by a common sensor, and may be separately provided from each other. The displacement amounts Kr, KI are not limited to the drive position (extension position, motor rotation speed) of the drive unit 4. Alternatively, for example, a door speed, an acceleration, and an expansion amount accumulation value are applicable as the displacement amounts Kr, KI. Further, the displacement amount difference M is changeable in accordance with a parameter of the displacement amounts Kr, KI.

According to the construction of the embodiment, the vehicle opening-and-closing member control device (power liftgate apparatus 3) performs an automatic opening and closing control of the vehicle opening-and-closing member (rear door 2) by controlling the plural drive units (4a, 4b) having a drive force for operating the vehicle opening-and-closing member (rear door 2). The vehicle opening-and-closing member control device (power liftgate apparatus 3) includes the plural displacement amount detection portions (pulse sensors 22a, 22b) provided at the plural drive units (4a, 4b), respectively, and detecting respective displacement amounts of the drive units (4a, 4b), the determination portion (failure determination portion 39) obtaining a relative difference of the displacement amounts detected by the displacement amount detection portions (pulse sensors 22a, 22b) and determining whether the drive unit (4a, 4b) is in failure on the basis of the difference of the displacement amounts, and a restriction portion (operation restriction portion 40) restricting an operation state of the opening-and-closing member (rear door 2) operated by the drive units (4a, 4b) so as to be an operation disapproval state where the opening-and-closing member (rear door 2) cannot be operated by the drive units (4a, 4b) in a case where the determination portion (failure determination portion 39) determines that at least one of the drive units (4a, 4b) fails and at least one of the drive units (4a, 4b) operates normally. The restriction portion (operation restriction portion 40) stops the operation of the drive units (4a, 4b) at the time when an occurrence of a failure of the drive unit (4a, 4b) or the drive units (4a, 4b) is determined during the drive units (4a, 4b) are in operation, and the restriction portion (operation restriction portion 40) prohibits the operation of the drive units (4a, 4b) thereafter when the occurrence of the failure of the drive unit (4a, 4b) or the drive units (4a, 4b) is determined during the drive units (4a, 4b) are not in operation.

According to the construction of the embodiment, because the displacement amount difference (displacement amount difference M) changes significantly in a case where one of the drive units (4a, 4b) fails, an occurrence of the failure at one of the plural drive units (4a, 4b) is recognizable by monitoring a value of the displacement amount difference (displacement amount difference M). Thus, with a simple construction for obtaining the displacement amount difference (displacement amount difference M), an occurrence of one of the plural drive units is assumed to be detectable.

Further, in a case where a difference is generated between the displacement amounts, it is necessary for the vehicle opening-and-closing member control device (power liftgate apparatus 3) to have an optimum operation. According to the construction of the embodiment, the vehicle opening-and-closing member control device (power liftgate apparatus 3) is configured to stop the operation of the drive unit or the drive units (4a, 4b) at the timing when recognizing that a failure of the drive unit or the drive units occur during the drive units (4a, 4b) are in operation, and is configured to prohibit the operation of the drive units thereafter when recognizing an occurrence of a failure of the drive unit or the drive unit during the drive units (4a, 4b) are not in operation. Thus, an optimum operation can be performed by the vehicle opening-and-closing member control device (power liftgate apparatus 3) when the difference is generated between the displacement amounts of the drive units (4a, 4b).

According to the construction of the embodiment, the vehicle opening-and-closing member control device (power liftgate apparatus 3) includes the cancellation portion (restriction cancellation portion 41) canceling the operation disapproval state restricted by the restriction portion (operation restriction portion 40) when a predetermined cancellation condition is satisfied.

According to the construction of the embodiment, a cancellation of the operation disapproval state, for example, despite the failure of the drive unit or the drive units being not repaired is prevented. Thus, the construction of the embodiment contributes to ensure a safety of a user when opening and closing the opening-and-closing member.

According to the construction of the embodiment, the predetermined cancellation condition includes that a predetermined time is elapsed from a time when the opening-and-closing member (rear door 2) is assumed to be the operation disapproval state.

According to the construction of the embodiment, a cancellation of the operation disapproval state despite the failure of the drive unit (4a, 4b) or the drive units (4a, 4b) being not repaired is prevented. Thus, the construction of the embodiment contributes to ensure a safety of a user when opening and closing the opening-and-closing member (rear door 2).

According to the embodiment, the vehicle opening-and-closing member control device (power liftgate apparatus 3) includes the cancellation portion (restriction cancellation portion 41) canceling the operation disapproval state restricted by the restriction portion (operation restriction portion 40) when a predetermined cancellation condition is satisfied, and maintaining the operation disapproval state restricted by the restriction portion (operation restriction portion 40) until the predetermined cancellation condition is satisfied.

According to the construction of the embodiment, because the operation disapproval state is maintained until the condition for canceling the operation disapproval state is satisfied after the operation state of the drive units is assumed to be the operation disapproval state, an occurrence of the cancellation of the operation disapproval state, for example, despite the failure of the drive unit (4a, 4b) or the drive units (4a, 4b) being not repaired is prevented. Thus, the construction further contributes to ensure a safety of a user when opening and closing the opening-and-closing member.

According to the embodiment, the vehicle opening-and-closing member control device (power liftgate apparatus 3) includes the brake portion (brake control portion 35) applying a brake force to the opening-and-closing member (rear door 2) to reduce an operation speed of the opening-and-closing member (rear door 2) when the determination portion (failure determination portion 39) determines the drive unit (4a, 4b) is in failure or the drive units (4a, 4b) are in failure.

According to the construction of the embodiment, because a brake force is applied to the opening-and-closing member (rear door 2) when an occurrence of a failure is determined, the opening-and-closing member (rear door 2) can be safely operated, thus contributing to ensure a safety of a user when opening and closing the opening-and-closing member (rear door 2).

According to the embodiment, the brake portion (brake control portion 35) corresponds to a regenerative brake portion for applying the brake force to the opening-and-closing member (rear door 2) by a regeneration by establishing a closed circuit at a drive circuit (motor drive circuits 21a, 21b) of the drive unit (4a, 4b).

According to the construction of the embodiment, because a brake force is applied to the opening-and-closing member (rear door 2) by the regenerative brake, the brake can be applied to the opening-and-closing member (rear door 2) with a simple construction that switches circuit states of the drive circuit.

According to the embodiment, the displacement amount corresponds to a drive position of the drive unit (4a, 4b) and the displacement amount difference (displacement amount difference M) corresponds to a difference between the drive positions of the drive units (4a, 4b).

According to the construction of the embodiment, an occurrence of a failure of the drive unit (4a, 4b) is assumed to be detectable with a simple construction that whether the failure occurs is determined on the basis of the drive position of the drive unit.

According to the embodiment, the vehicle opening-and-closing member control device (power liftgate apparatus 3) includes the operation control portion (automatic operation control portion 32) for controlling an operation of the opening-and-closing member (rear door 2) by controlling the drive units (4a, 4b) so that an operation speed of the opening-and-closing member (rear door 2) follows a target speed on the basis of a detection signal from an operation state detection portion (pulse sensors 22a, 22b) detecting an operation state of the opening-and-closing member (rear door 2).

According to the construction of the embodiment, when automatically closing the opening-and-closing member, the speed of the opening-and-closing member is controlled to follow the target speed, thus the opening-and-closing member can be operated with a favorable speed.

According to the embodiment, the displacement amount corresponds to one of a drive speed of the drive unit (4a, 4b), a drive acceleration of the drive unit (4a, 4b), and a drive amount accumulation value of the drive unit (4a, 4b).

According to the construction of the embodiment, a failure of the drive unit is detectable with a simple construction that determines whether a failure occurs on the basis of one of the drive speed of the drive unit, the drive acceleration of the drive unit, and the drive amount accumulation value.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle opening-and-closing member control device for performing an automatic opening and closing control of a vehicle opening-and-closing member by controlling a plurality of drive units having a drive force for operating the vehicle opening-and-closing member, the vehicle opening-and-closing member control device comprising:
a plurality of displacement amount detection portions provided at said plurality of drive units, respectively, and detecting respective displacement amounts of the drive units;
a determination portion obtaining a relative difference of the displacement amounts detected by the displacement amount detection portions and determining whether the drive unit is in failure on the basis of the difference of the displacement amounts;
a restriction portion restricting an operation state of the opening-and-closing member operated by the drive units so as to be an operation disapproval state where the opening-and-closing member cannot be operated by the drive units in a case where the determination portion determines that at least one of the drive units fails and at least one of the drive units operates normally; and wherein
the restriction portion stops the operation of the drive units at the time when an occurrence of a failure of the drive unit or the drive units is determined during the drive units are in operation, and the restriction portion prohibits the operation of the drive units thereafter when the occurrence of the failure of the drive unit or the drive units is determined during the drive units are not in operation.

2. The vehicle opening-and-closing member control device according to claim 1, further comprising:
a cancellation portion canceling the operation disapproval state restricted by the restriction portion when a predetermined cancellation condition is satisfied.

3. The vehicle opening-and-closing member control device according to claim 2, wherein the predetermined cancellation condition includes that a predetermined time is elapsed from a time when the opening-and-closing member is assumed to be the operation disapproval state.

4. The vehicle opening-and-closing member control device according to claim 1, further comprising:
a cancellation portion canceling the operation disapproval state restricted by the restriction portion when a predetermined cancellation condition is satisfied, and maintaining the operation disapproval state restricted by the restriction portion until the predetermined cancellation condition is satisfied.

5. The vehicle opening-and-closing member control device according to claim 1, further comprising:
a brake portion applying a brake force to the opening-and-closing member to reduce an operation speed of the opening-and-closing member when the determination portion determines the drive unit is in failure or the drive units are in failure.

6. The vehicle opening-and-closing member control device according to claim 2, further comprising:
a brake portion applying a brake force to the opening-and-closing member to reduce an opening and closing speed of the opening-and-closing member when the occurrence of the failure of the drive unit or the drive units is determined.

7. The vehicle opening-and-closing member control device according to claim 4, further comprising:
a brake portion applying a brake force to the opening-and-closing member to reduce an opening and closing speed of the opening-and-closing member when the occurrence of the failure of the drive unit or the drive units is determined.

8. The vehicle opening-and-closing member control device according to claim 5, wherein the brake portion corresponds to a regenerative brake portion for applying the brake force to the opening-and-closing member by a regeneration by establishing a closed circuit at a drive circuit of the drive unit.

9. The vehicle opening-and-closing member control device according to claim 1, wherein the displacement amount corresponds to a drive position of the drive unit and the displacement amount difference corresponds to a difference between the drive positions of the drive units.

10. The vehicle opening-and-closing member control device according to claim 2, wherein the displacement amount corresponds to a drive position of the drive unit and the displacement amount difference corresponds to a difference between the drive positions of the drive units.

11. The vehicle opening-and-closing member control device according to claim 4, wherein the displacement amount corresponds to a drive position of the drive unit and the displacement amount difference corresponds to a difference between the drive positions of the drive units.

12. The vehicle opening-and-closing member control device according to claim 5, wherein the displacement amount corresponds to a drive position of the drive unit and the displacement amount difference corresponds to a difference between the drive positions of the drive units.

13. The vehicle opening-and-closing member control device according to claim 8, wherein the displacement amount corresponds to a drive position of the drive unit and the displacement amount difference corresponds to a difference between the drive positions of the drive units.

14. The vehicle opening-and-closing member control device according to claim 1, further comprising:
an operation control portion for controlling an operation of the opening-and-closing member by controlling the drive units so that an operation speed of the opening-and-closing member follows a target speed on the basis of a detection signal from an operation state detection portion detecting an operation state of the opening-and-closing member.

15. The vehicle opening-and-closing member control device according to claim 2, further comprising:
an operation control portion for controlling an operation of the opening-and-closing member by controlling the drive units so that an operation speed of the opening-and-closing member follows a target speed on the basis of a detection signal from an operation state detection portion detecting an operation state of the opening-and-closing member.

16. The vehicle opening-and-closing member control device according to claim 4, further comprising:
an operation control portion for controlling an operation of the opening-and-closing member by controlling the drive units so that an operation speed of the opening-and-closing member follows a target speed on the basis of a detection signal from an operation state detection portion detecting an operation state of the opening-and-closing member.

17. The vehicle opening-and-closing member control device according to claim 5, further comprising:
an operation control portion for controlling an operation of the opening-and-closing member by controlling the drive units so that an operation speed of the opening-and-closing member follows a target speed on the basis of a detection signal from an operation state detection portion detecting an operation state of the opening-and-closing member.

18. The vehicle opening-and-closing member control device according to claim 8, further comprising:
an operation control portion for controlling an operation of the opening-and-closing member by controlling the drive units so that an operation speed of the opening-and-closing member follows a target speed on the basis of a detection signal from an operation state detection portion detecting an operation state of the opening-and-closing member.

19. The vehicle opening-and-closing member control device according to claim 9, further comprising:
an operation control portion for controlling an operation of the opening-and-closing member by controlling the drive units so that an operation speed of the opening-and-closing member follows a target speed on the basis of a detection signal from an operation state detection portion detecting an operation state of the opening-and-closing member.

20. The vehicle opening-and-closing member control device according to claim 1, wherein the displacement amount corresponds to one of a drive speed of the drive unit, a drive acceleration of the drive unit, and a drive amount accumulation value of the drive unit.
